(19) United States
(12) Patent Application Publication
(10) Pub. No.: US 2005/0275843 A1
(43) Pub. Date: Dec. 15, 2005

(54) Pre-mixing device to reduce the pulses of chemicals during their dosage in dyeing processes

(76) Inventor: Wolf Iberkleid, La Paz (BO)

Correspondence Address: LADAS & PARRY, 26 WEST 61ST STREET, NEW YORK, NY, 10023, US

(21) Appl. No.: 11/151,114

(22) Filed: Jun. 13, 2005

Related U.S. Application Data
(60) Provisional application No. 60/579,492, filed on Jun. 14, 2004.

(51) Int. Cl. G01J 3/46

(52) U.S. Cl. 356/402

(57) ABSTRACT

A pre-mixing device (MA) pre-mixes dye from a preparation tank (PT) and dye bath from a main tank (MT) of a piece dyeing machine for return to the main tank to die fabric, for example.

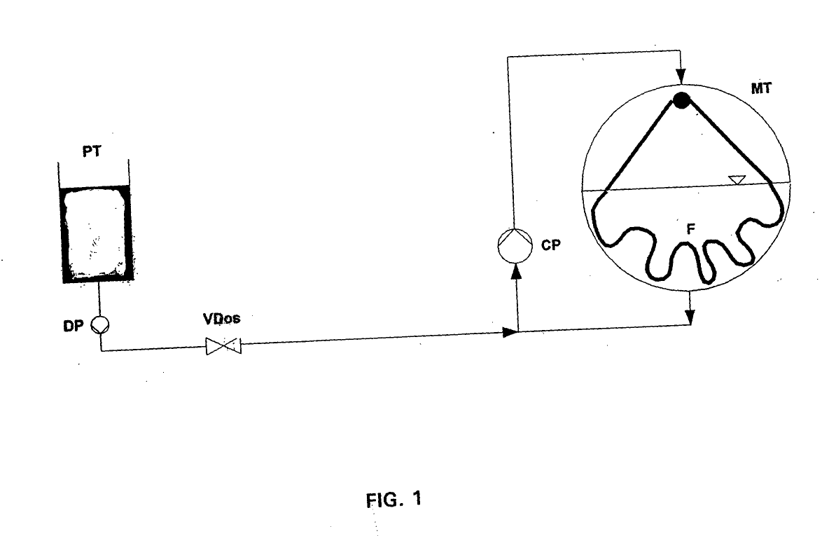

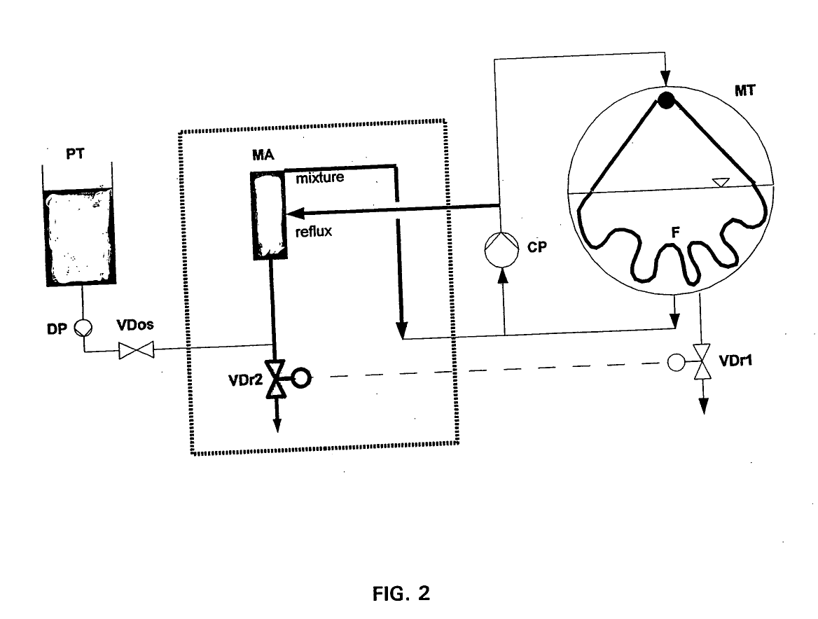

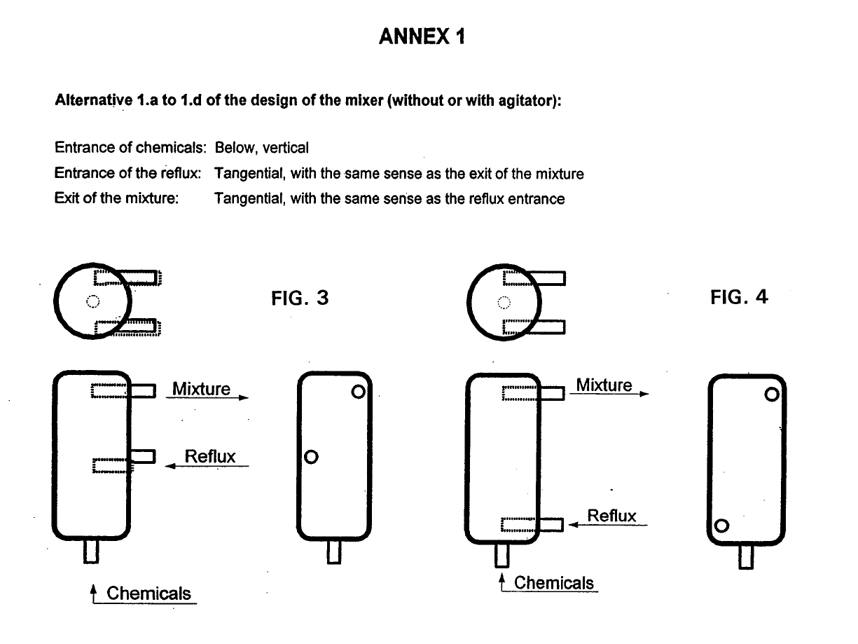

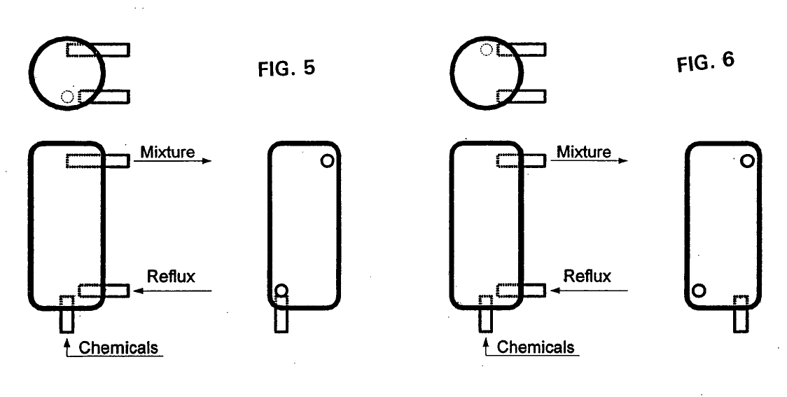

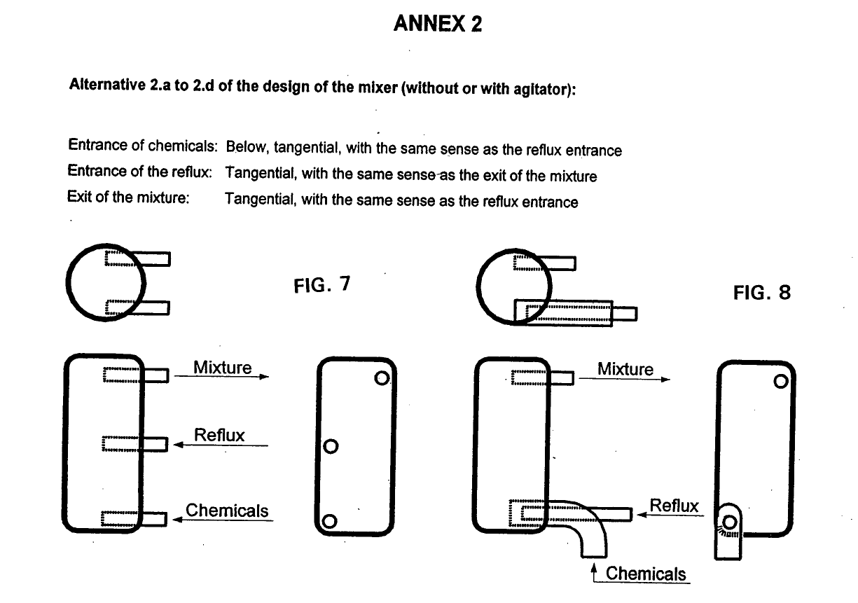

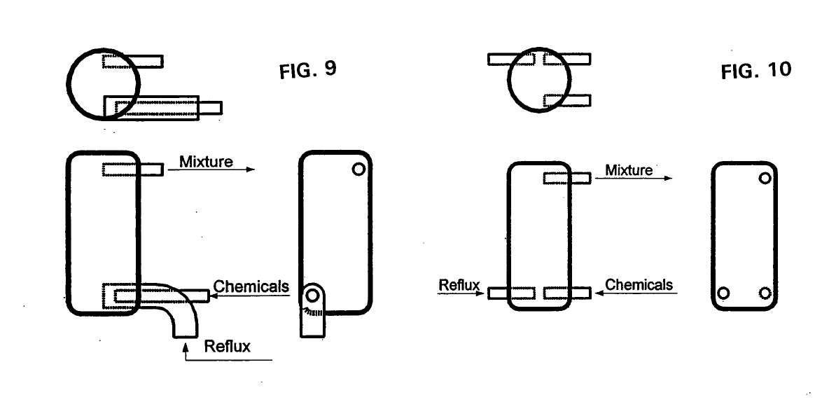

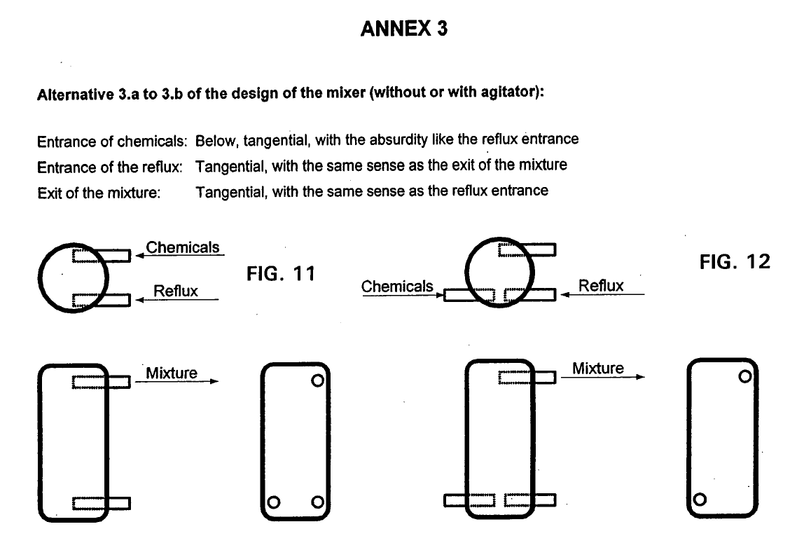

### INTRODUCTION

A piece dyeing machine consists mainly of a main tank (MT, see drawing) and a pump for the circulation of the dye bath (CP). The dye bath is circulating constantly to penetrate the fabric (MP) that is in the dyeing machine.

In the different stages of the dyeing process the fabric needs to be contacted with chemical as for example dyes or other Chemicals. These chemicals are dosed from a preparation tank (F) via a dosage pump (DP) and a control valve (VDos) to the main tank of the dyeing machine. The goal of the dosage is to increase the concentration of chemicals in the dyeing machine. The main problem of this process is to mix the chemicals, as for example dyestuffs, in a homogeneous manner with the circulating dye bath. That is necessary to guarantee a good quality of the fabric.

Most of the existing dyeing machines control the dosage of the chemicals in a way that does not guarantee a rapid homogenization. For example, they are using digital valves (completely open or closed) to control the dosage. This way to control a dosage causes pulses of the chemicals. These pulses of chemicals are migrating via the circulating dye bath to the fabric. According to the type of chemical and its concentration in the pulse we can encounter problems in the fabric like for example staining.

To solve this problem some companies have designed an intermediary tank between the preparation tank and the dyeing machine that allows eliminating the pulses of chemicals. This design needs a high level of additional equipment (open tank, agitator, chemical pump, valves) and an additional system to control a level or flow. Therefore the fabrication of a new pre mixing device of this type has a high cost. The modification of existent machines would still cause even higher costs because additionally they need to modify the whole control system.

### SUMMARY

The present invention refers to the improvement of a pre-mixing device for dyeing processes that guarantees the homogeneous mixture of the chemicals with the dye-bath that circulates in the dyeing machine. This new system operates without any control mechanisms and is easily to fabricate and install in all types of exiting dyeing machines.

### THE NEW INVENTION

It has been designed and put into operation a pre-mixing device that allows eliminating pulses of chemicals during their dosage. The great advantage and novelty of this system is that it consists of a very simple equipment, control mechanisms are not needed, and it can be installed (as a plug & play kit) easily in any existent machine

The design consists of the following equipment:

A mixing autoclave (MA)

Drainage valves (VDr2)

Connection pipes

This system is installed between the preparation tank and the dyeing machine as indicated in the following drawing.

### EXAMPLE OF THE DESIGN FOR A MIXER WITHOUT ADDITIONAL AGITATOR

Dyeing machine with 2000 L dye bath

Dosage of 100 L of chemicals during 10 minutes.

There are dosage pulses every 2 seconds.

According to point 1 and 2: 10 L<V_{MA}<100 L

We decide to install a mixer of 20 L

According to point 3: Design according to drawings A 1.a or A 2.a (see annexed)

According to restriction 4 and 5.: ⅔ L/s<reflux Flow<5 L/s

Production according to the points 6, 7 and 8

### EXAMPLE OF THE DESIGN FOR A MIXER WITH ADDITIONAL AGITATOR

Dyeing machine with 2000 L dye bath

Dosage of 100 L of chemicals during 10 minutes.

There are dosage pulses every 2 seconds.

According to point 1 and 2: 10 L<V_{AA}<100 L

We decide to install a mixer of 10 L

According to point 3: Geometry of autoclave not →cylinder with height and diameter of 24 cm

According to restriction 4 and 5.: ⅙ L/s<reflux Flow<2,5 L/s

Production according to the points 6, 7 and 8

1. (canceled)

2. Constellation and design of equipment to dose chemicals constantly and in homogeneous manner without the need of intervening in the control system of an existing machine and without additional pump.

3. Constellation and design according to claim 2, and further comprising geometry of the premixing autoclave of the chemicals without or with agitator.

4. (canceled)

5. Procedure of fabrication of the device based on the characteristics of any dyeing machine.

6. In a dyeing machine having a main tank for a dye bath, a preparation tank for preparing dye for the dye bath and a pump for circulating the dye bath with the dye to, through, from and back to the main tank, the improvements comprising:
a pre-mixing device for mixing the dye with the dye bath before the circulating of the dye bath with the dye back to the main tank.
